(19) United States
(12) Patent Application Publication
(10) Pub. No.: US 2007/0085889 A1
(43) Pub. Date: Apr. 19, 2007

(54) Method of printing on a media

(75) Inventors: Ana Maria Cardells, Barcelona (ES); Alejandro Campillo, Barcelona (ES); Marc Serra, Barcelona (ES); Angel Martinez Barambio, Barcelona (ES)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: Hewlett-Packard Development Company, L.P.

(21) Appl. No.: 11/249,338

(22) Filed: Oct. 14, 2005

(51) Int. Cl. B41J 2/01

(52) U.S. Cl. 347/101

(57) ABSTRACT

The invention relates to a method of printing on a media comprising: providing a printhead 300 comprising a plurality of nozzles (301, . . . , 310, . . . , 319, . . . ) defining a print zone, at least one 310 of the nozzles of the print zone being faulty, the print head comprising within the print zone one or more healthy zones 371, 372; submitting a first region 281 of the media to N print zone passes; and, submitting a second region 282 of the media to M print zone passes using a healthy zone to overlap a faulty nozzle, at least two of the M passes being separated by an advance of the media relative to the printhead; producing alternate first and second regions when printing on the media; whereby M>N and N>0.

### FIELD OF THE INVENTION

The invention relates to the field of printing using a printhead carrying a plurality of nozzles, and more particularly to the correction or compensation of printing defaults which may be introduced by faulty nozzles.

### BACKGROUND OF THE INVENTION

Printing may be achieved by a broad variety of methods, some of which using a nozzle carrying printhead, whereby the nozzles eject drops of ink onto a media to built a picture onto the media. Such printing systems are typically provided with systems controlling the nozzles in order to obtain the desired result. There is a tendency to increase the number of nozzles and the concentration of nozzles placed on a printhead in order to increase both printing speed and printing definition. At the same time, the manufacturing costs of a printhead need to be maintained as low as possible, in particular in case of a disposable printhead which is meant to be replaced at the end of its lifetime. The combination of these factors means that some nozzles may become faulty. Faulty nozzle may negatively impact the quality or the speed of printing.

### PRIOR ART

There are known methods of compensating faulty nozzles. A first method is disclosed for example in U.S. Pat. No. 6863361 which consists in compensating a faulty nozzle using neighboring nozzles. An embodiment of this method is illustrated on FIG. 6 where a printhead 600 is represented, the printhead carrying 22 nozzles, one of which, nozzle 610, being faulty. In this case, the print mask is media, so that quality is not compromised. The speed is however greatly affected in that the multi pass mode as described in EP0863004 multiplies the number of passes by a factor of 2 or more, so that the speed is reduced by a similar factor.

### SUMMARY OF THE INVENTION

The object of the invention is to improve a method of the type set forth such that the impact on quality and/or speed of printing is minimized. This object is achieved in a first aspect by a method of printing on a media comprising:
providing a printhead comprising a plurality of nozzles defining a print zone, at least one of the nozzles of the print zone being faulty, the print head comprising within the print zone one or more healthy zones;
submitting a first region of the media to N print zone passes; and,
submitting a second region of the media to M print zone passes using a healthy zone to overlap a faulty nozzle, at least two of the M passes being separated by an advance of the media relative to the printhead;
producing alternate first and second regions when printing on the media; whereby M>N and N>0.

The invention relates to printing on a media. The media used is typically a sheet of paper, which may be a laminate, and may also be made of or comprise plastic resins or textile fibers, woven or non woven. The media may be provided in the form of a roll. The media is typically laminar, but may have a variety of shapes, for example packages such as bottles or boxes and the like. The media is typically flexible such as a sheet of paper but may also be rigid, such as card board or wood.

A printhead is provided. The printhead, sometimes also called pen, may be of the disposable type or may be a permanent printhead. The printhead may include one or more ink container, and/or may be linked by one or more conducts to one or more separated ink reservoirs. Printing is normally incremental in that the printhead is scanned over the media while firing the nozzles in order to print on the area of the media facing the printhead, the media being thereafter advanced in relation to the printhead in a direction typically perpendicular to the scanning direction, the printhead scanning the media another time while firing the nozzles on another area of the media. The printhead comprises a plurality of nozzles. In a first embodiment, the printhead comprises at least 200 nozzles. In another embodiment, the printhead comprises at least 500 nozzles. In another embodiment, the printhead comprises at least 1000 nozzles. The plurality of nozzles defines an elongated print zone. The elongated print zone comprises only the nozzles meant for printing. It should indeed be noted that in an embodiment, the printhead comprises a first plurality of nozzle and a second plurality of nozzles, whereby the first plurality comprises all nozzles of the second plurality as well as additional nozzles which are not used for printing, whereby the print zone is formed of the nozzles of the second plurality. In this embodiment, the total number of nozzles is larger than the number of nozzles of the second plurality to allow for calibration of the printhead. Such a calibration is illustrated in FIG. 1, whereby a print head comprises a total of 12 nozzles forming the first plurality, and whereby the print zone comprises only 8 of these nozzles which may be chosen as being more or less towards one side or another as illustrated in FIG. 1 whereby a first 10, second 11 or third print zone 12 may be chosen in order to compensate for example for possible misplacement of the printhead in relation to another printhead or in relation to the media, or in relation to other elements of the printing systems. Other print zones may be chosen. A print zone is normally formed from a coherent group of nozzles. By coherent group, it should be understood that the nozzles which are part of the group cohere, in so far as the whole group of nozzle does not include any faulty nozzles in its mass, and in so far as the group includes all adjacent nozzles. In an embodiment, the coherent nozzles are consecutive nozzles. The nozzles X which are not part of the print zone are normally not used for printing. The print zone comprises most of the nozzles of the printhead. In an embodiment, the print zone comprises at least modified to have for example neighboring nozzles 609 and 611 compensate for the faulty nozzle 610. On FIG. 6, three printhead passes are represented being pass 630, 640 and 650. Each of these passes corresponds to printing on a zone described by, respectively, arrows 631, 641 and 651. In the representation, the printhead is moved from one pass to the next, whereas in reality the typical situation is that the media is moved. In any case, the printhead moves in relation to the media. During printing, the printhead scans in a direction indicated by arrow 670, either in one sense or in the other. This first method has the advantage of maintaining the speed of the print, but has the disadvantage of compromising quality. In the case of technical CAD (computer assisted drawing) drawings, for example, the position and thickness of a line may be essential, in which case the compensation of a faulty nozzle using neighboring nozzles is not a satisfactory solution. A second method is disclosed for example in EP0863004 which consists in passing the print zone of the printhead several times onto the media at different positions, so that a faulty nozzle which could not be fired in one pass could be compensated by firing a replacement nozzle at another pass. An example of this method is represented in FIG. 5, whereby the same printhead is used as in FIG. 6, the printhead passing in the same direction of arrow 670, where this time 4 passes are described being passes 510, 520, 530 and 540 for printing on zones 511, 521, 531 and 541. It should be noted that in the representation of the figures, more passes typically take place which are not represented. In this example, any region of the medium is passed over twice by the print zone of the print head (arrows 511, 521, 531 and 541 each overlap the previous and the next arrow). The advantage is that the pass of faulty nozzle 610 is compensated by a pass of healthy nozzle 621 at the same location, so that the quality is maintained. The speed is however reduced compared to the example illustrated in FIG. 6 where the medium is submitted to one pass only (there is no overlap of arrow 631, 641 and 651). The area printed in 3 passes in the example of FIG. 6 is indeed about double the area printed in 3 passes in the example of FIG. 5. The advantage of this second method is that the position of the replacement nozzle relative to the media may be the same as the position of the faulty nozzle relative to the 85% of all nozzle of the printhead. In an embodiment, the print zone comprises at least 95% of all nozzle of the printhead. The print zone is typically elongated in the direction perpendicular to the scanning direction of the printhead.

According to the first aspect of the invention, at least one nozzle is faulty. A faulty nozzle may be blocked, plugged, oriented in the wrong direction etc. There are methods of detection of faulty nozzles described in the art. There may be more than one faulty nozzle. According to the invention, the faulty nozzle is a nozzle of the print zone. A faulty nozzle outside of the print zone would be of consequence for calibration purposes.

The print zone comprises one or more healthy print zones, whereby a healthy print zone is composed of a coherent group of healthy nozzles. It should be understood that a healthy zone may be formed of a single nozzle if for example all adjacent nozzles are faulty nozzles. A healthy zone does not include any faulty nozzle, and there is not any healthy nozzle adjacent a healthy zone. If a first healthy nozzle is adjacent to a second healthy nozzle, both are part of the same healthy zone. The print zone is formed of the complementary and disjoint addition of one or more faulty nozzles and of one or more healthy zones. In an embodiment, a healthy zone is formed of consecutive nozzles.

According to the first aspect of the invention, a first region of the media is submitted to N print zone passes. A pass may be in a scanning direction or in the opposite scanning direction. Any part of the first region will “see” N passes of the print zone. In an embodiment, the first region is submitted to only one print zone pass. It should be understood that the first region does not see N pass of the complete print zone. Any part of the first region is passed over only N times by some part of the print zone and is not passed more than N times by any part of the print zone. This first region corresponds to what would be called a one pass mode in the case where N=1. In an embodiment, a complete first region has a rectangular shape limited by the sides of the media perpendicular to the printhead scanning direction and by lines parallel to the scanning direction. N is a non zero positive natural integer.

According to the first aspect of the invention, a second region of media is submitted to M print zone passes. M is a positive natural integer superior to N. M is not equal to N. At least 2 of the M passes are separated by an advance of the media relative to the printhead. The N print zone passes are such that the trajectory of a faulty nozzle in one pass is followed by passing a healthy nozzle in another pass, in this order or in the inverted order. In an embodiment, N=1 and M=2.

According to the first aspect of the invention, the print is produced by alternating first and second regions.

Considering that the method according to the invention comprises printing regions submitted to a different number of print zone passes, extra flexibility is gained for compensation of faulty nozzle while minimizing the compromise in speed when compared to the methods disclosed in EP0863004 or in U.S. Pat. No. 6863361 where printing is either mono pass or multi pass and where any printed region is submitted to the same number of passes for a given print.

In an embodiment of the first aspect of the invention, the print zone has two or more healthy zones including a first healthy zone and a second healthy zone, and whereby the second healthy zone is shorter or equal to the first healthy zone, and whereby printing comprises the following steps:
advancing the media relative to the printhead of a first distance;
print a swath on the media;
advancing the media relative to the printhead of a second distance;
   whereby the first distance is different from the second distance, the first distance being the length of the second healthy zone, and the second distance being the sum the following:
the length of the first healthy zone; and
the length of the second healthy zone; and
the space between the first and the second healthy zones
   and whereby the length of the longest healthy zone is smaller or equal to the average value of the second distance and of the length of the second healthy zone.

In this particular embodiment, at least one faulty nozzle is located away from an end of the print zone, thus defining at least two healthy zones, at least one on each side of the faulty nozzle (or of the group of faulty nozzles). There may be more than two healthy zones. The first healthy zone is longer or equal to the second healthy zone. In a case where the first and the second healthy zone are of equal length, any may be considered the first zone, respectively second. It should be noted that the length of a healthy zone is understood as being the length along a direction perpendicular to the direction of scanning of the printhead, which normally corresponds to the direction of media displacement. The method comprises the step of advancing the media, typically using a media advance mechanism such as a roller system, a piezo system, a conveyor system, a vacuum system of a suction system for example. The method further comprises printing a swath on the media. A swath is typically a band parallel to the scan axis of the printhead having a width in the direction perpendicular to the scan axis of the print head (called “scan axis”) typically corresponding to the length of the print zone along a direction perpendicular to the scan axis. The surface area of the swath normally corresponds to the increment in printed surface area after a particular scan of the printhead. The method further comprises advancing the media of a second distance, typically in a direction perpendicular to the scan axis. In an embodiment, both the advance of the media of a first distance and of a second distance are in the same direction and in the same sense. In an embodiment, the step of advancing the media a first distance, printing a swath and advancing the media a second distance are taking place in this order. The first distance is the length of the second healthy zone, which corresponds to the maximum length of advance of the media without leaving a faulty nozzle uncovered by a further pass. The second distance is maximized in order to maximize the printing speed in that the second distance is equal to the sum of three lengths along the media displacement axis which is normally perpendicular to the scan axis being the length of the first healthy zone, the length of the second healthy zone and the length of the space separating the first and the second healthy zone. In an embodiment, the space separating or between the first and the second healthy zone only comprises one or more faulty nozzles. In another embodiment, the space separating or between the first and the second healthy zone comprises at least one further healthy zone. According to the method, the length of the longest healthy zone is smaller or equal to the average value of the second distance and of the length of the second healthy zone. The average value of the second distance and of the length of the second healthy zone corresponds to the arithmetic mean value of the first and second distances, which in turn is related to the average printing speed. This mean value is compared to the length of the longest healthy zone. If the longest healthy zone is longer or equal to this mean value, a print made using the longest healthy zone as print zone would have the same or a higher speed than the speed obtained by the method, while maintaining optimal quality as the longest healthy zone has no faulty nozzles. In an embodiment the first healthy zone is on the side of a first end of the print zone, the second healthy zone is on the side of the second end of the print zone opposite to the first end, and any or both of the first or second healthy zone is separated from the first or respectively second end by one or more healthy zones. In this embodiment, the relative position of the first and the second healthy zone is considered, whereby the order is in sequence a first end of the print zone, the first healthy zone, the second healthy zone and the second end of the print zone, considering that other healthy zones may be located in between. An end of the print zone is corresponding to an outer limit of the print zone. In this embodiment, at least one of or both of the first or second healthy zone is separated from its respectively associated end by one or more extra healthy zones. These extra healthy zones will not be used when printing, so that printing takes place without using these extra healthy zones. This is equivalent to redefining a new print zone which would exclude these extra healthy zones. In an embodiment, this is applied if a faulty nozzle continuous to an extra healthy zone could not be compensated by an extra pass without compromising printing speed in an excessive manner. In another embodiment, there is no healthy zone separating one or both of the first or second healthy zone from the first or respectively second end, which means that no extra healthy zone exist which would not be used when printing.

In another embodiment, a method according to the invention comprises a further step of compensating a faulty nozzle using one or more neighboring nozzles, a neighboring nozzle being a healthy nozzle adjacent to a faulty nozzle.

In an embodiment of the first aspect, the print zone has only one healthy zone, printing comprises the following steps:
advancing the media relative to the printhead of a first distance;
print a swath on the media;
advancing the media relative to the printhead of a second distance;
   whereby the first distance is equal to the second distance, the first and the second distance being both equal to the length of the only one healthy zone. This mechanism would correspond to redefining a new print zone comprising only healthy nozzles and being the only one healthy zone.

In an embodiment of the first main aspect, a main healthy zone is identified, the main healthy zone being the longest healthy zone and the main healthy zone being longer than half the length of the print zone, whereby printing comprises the following steps:
advancing the media relative to the printhead of a first distance;
print a swath on the media;
advancing the media relative to the printhead of a second distance;
   whereby the first distance is equal to the second distance, the first distance being the length of the main healthy zone. In this particular embodiment, the main healthy zone corresponds to a newly defined print zone which newly defined print zone would not comprise faulty nozzles. It should be noted that in the case of a main healthy zone smaller or equal to half the length of the print zone according to the invention, using only this main healthy zone would reduce the printing speed down to the printing speed equivalent to the speed obtained when using a 2 pass mode as described in EP0863004. In such a case, a 2 pass mode as described in EP0863004 would likely also give a poor printing result, so that the print head itself should be discarded and replaced, or fixed.

In an embodiment of the first main aspect, printing is made by a succession of swaths, whereby each swath comprises at least part of the first region and at least part of the second region.

In an embodiment of the first main aspect, printing is made by a succession of swath, whereby each swath has a width corresponding to the length of a healthy zone.

In an embodiment of the first main aspect, each swath has a width smaller than the length of the print zone and larger that half the length of the print zone.

In an embodiment of the first main aspect, printing is made by a succession of swaths, whereby each swath differs in width from the following swath and whereby every second swaths have the same width.

The object of the invention is achieved in a second aspect by a method of printing a media using a print head having a plurality of nozzles comprising the repetition of the following cycle:
advancing the media relative to the printhead of a first distance;
print a swath on the media;
advancing the media relative to the printhead of a second distance;
print another swath on the media;
   whereby the length of the first distance and the length of the second distance are determined in function of the position of at least one faulty nozzle on the print head. An adaptive printing mode involving the possibility to set different values or equal values for advancing the media would indeed permit taking the position of a faulty nozzle into account when defining the appropriate print mode in order to allow a minimal quality or speed compromise.

The object of the invention is achieved in a third aspect by a method of choosing a print mode for a print head comprising the following steps:
identify all healthy zones of a printhead, each healthy zone being included in a print zone of the print head;
choose a print mode out of a plurality of available print modes depending on the configuration of the healthy zones, whereby the plurality of available print modes includes at least one available print mode involving a method according to the second aspect of the invention.

The object of the invention is achieved in a fourth aspect by a software, optionally encoded upon a machine-readable storage medium, which when executed upon a processor causes the processor to apply the method according to the third aspect of the invention. The machine readable medium may take of a variety of forms such as permanent memory, short term memory, disk, DVD, etc.

The object of the invention is achieved in a fifth aspect by a printer provided with a memory and a processor, whereby the memory comprises the software according to the fourth aspect of the invention. Such a printer would then offer print mode adapted to the position of one or more faulty nozzles in order to minimize compromise on speed or quality.

### BRIEF DESCRIPTION OF THE DRAWINGS

FIG. 1 is a schematic representation of a print head illustrating a variety of, print zone choices.

FIG. 2 illustrates a first embodiment of the invention.

FIG. 3 illustrates a second embodiment of the invention.

FIG. 4 illustrates a third embodiment of the invention.

FIG. 5 illustrates an example of prior art.

FIG. 6 illustrates another example of prior art.

### DETAILED DESCRIPTION

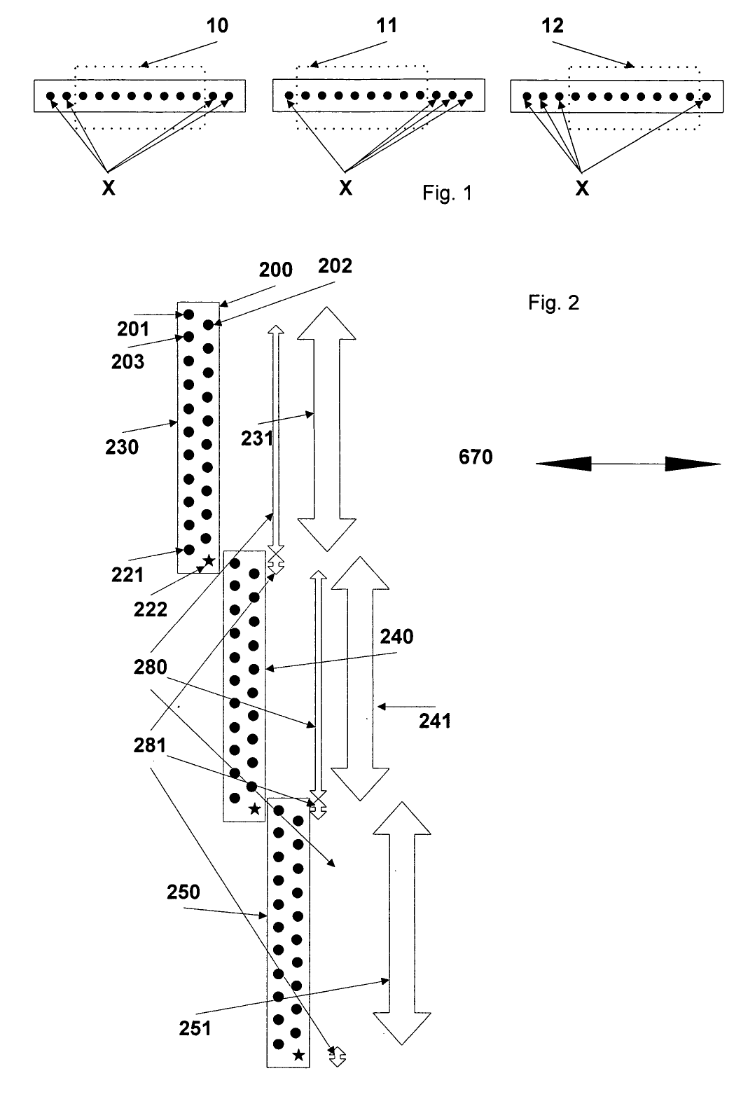

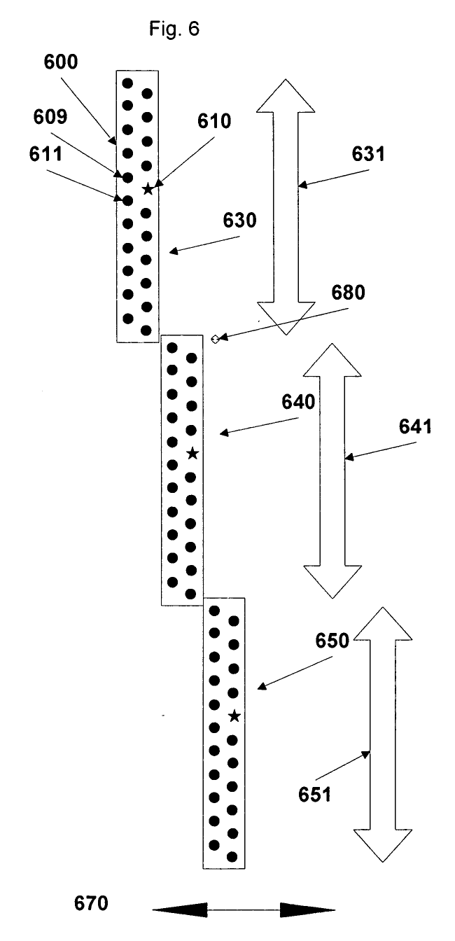

FIG. 2 is a representation of a first embodiment of the invention where a print head 200 carries 22 nozzles, which are consecutively numbered 201 to 222 (not all of them are numbered on FIG. 2 to avoid confusion). The printhead has one faulty nozzle 222. In this and in the following embodiments, only the nozzles forming the print zone are represented. Nozzles such as nozzles X of FIG. 1 are not represented to avoid confusion. Such extra calibration nozzles may or may not be provided. This particular printhead therefore has a print zone comprising nozzles 201 to 222, and one healthy zone only, comprising nozzles 1 to 221. It should be noted that in this particular example the nozzles are disposed in two columns and staggered. In other embodiments, one column or more than two columns may be used. In order to avoid a compromise on quality, the printing method used in this embodiment involves advancing the medium of a distance corresponding to the length of the only healthy zone instead of advancing of a distance corresponding to the length of the print zone, the lengths being measured along a direction perpendicular to the scan axis, the scan axis being defined by arrow 670. This is to ensure that the trajectory of the faulty nozzle 222 gets compensated by the passing of nozzle 1 in the following pass. This implies that each first region 280 will see only one pass, being the region printed by nozzles 202 to 221, whereas each second region 281 will see two passes, one with nozzle 222 and the other with nozzle 221. It should be noted that the print zones or the healthy zones are defined from nozzle to nozzle. In other words, the fact that there is in the example of FIG. 6 a region 680 which sees two passes of the printhead is not relevant as this region 680 does not see two nozzle passes or two print zone passes. In FIG. 2, three passes 230, 240 and 250 are represented, whereby the printhead is advanced of a distance 231, 241, 251 equal to the length of the only healthy zone between passes.

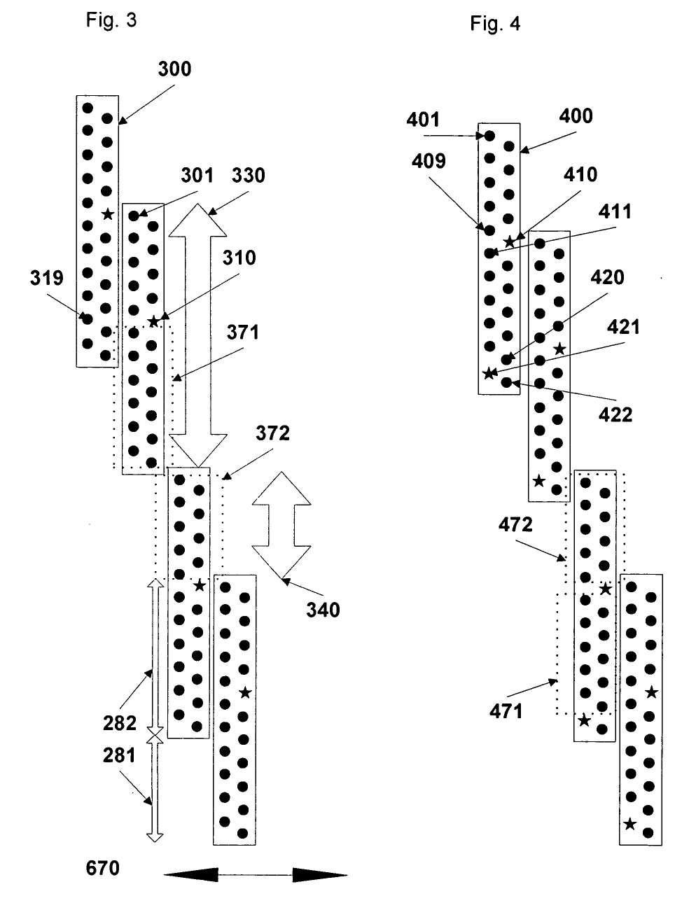

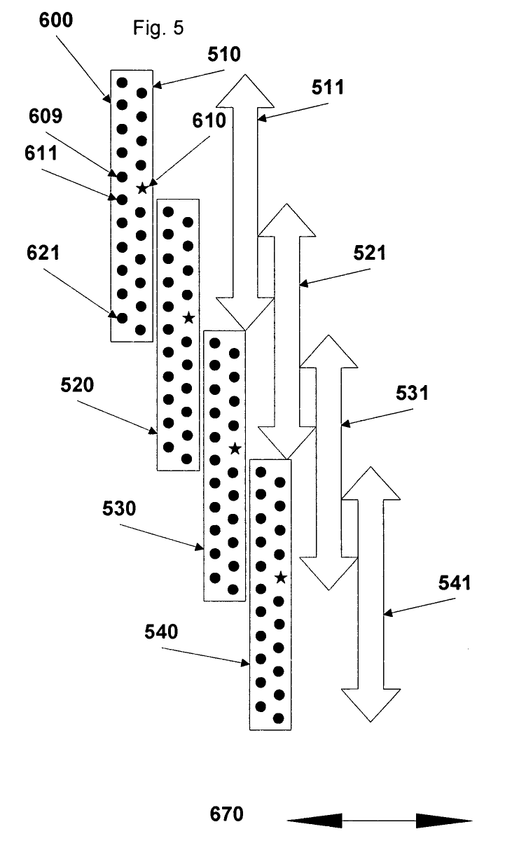

FIG. 3 illustrates the embodiment where a printhead 300 has one faulty nozzle 310, which is compensated in a following pass by the nozzle 301 or in the previous pass by nozzle 319. In this case, there are two healthy zones, the first one 371 and the second 372, whereby 371 is longer than 372, whereby the media is advanced in relation to the printhead of a first distance 330 and alternatively of a second distance 340, the second distance being the length of the second healthy zone 372, and the first distance being the sum of the length of the first and second healthy zone and of the space between them. In this case the first distance corresponds to the length of the print zone. The printed media is created by alternating a first region 281 submitted to one print zone pass and a second region 282 submitted to two print zone passes. On FIG. 3, four swaths are represented. The average advance per swath is the mean value of the first and second distances, which is higher than the average advance which would be obtained using a mode as described in FIG. 5. At the same time, quality is maintained by ensuring that the trajectory of the faulty nozzle is always compensated by a pass of a healthy nozzle.

FIG. 4 illustrates an embodiment where the print zone comprises two faulty nozzles 410 and 421. In this case, the there are three healthy zones, one of which being formed of nozzle 422 only. The second healthy zone 472 comprises nozzles 401 to 409 and the first healthy zone comprises nozzles 411 to 420. Between each swath, the media advances of either a second distance equal to the length of the second healthy zone or, alternatively, of a first distance equal to the addition of the lengths of the first healthy zone, second healthy zone, and of the length of the space separating them. Again, the average printing speed is faster than using the mode illustrated in FIG. 5, and the quality is maintained by ensuring that the pass of a faulty nozzle is compensated by the pass of a healthy nozzle.

In an embodiment of the invention, a software is provided which causes a processor to apply a method consisting in choosing a particular print mode for printing using a printhead having a plurality of nozzles, at least one of which being faulty according to the invention. The printhead is itself part of a large format printer. The printhead carries 1056 nozzles, 1040 of which are part of the print zone. The nozzles are distributed in two columns, staggered. Any faulty nozzle of the print zone is detected. The method then goes on to model printing by each print mode out of a group of available print modes, the group of available print modes comprising any multi-pass print mode as described in EP863004 (hereby incorporated by reference), any one pass print mode as described in U.S. Pat. No. 6,863,361 (hereby incorporated by reference) as well as any print mode according to the present invention. Once the various print modes are modeled, the method chooses either the fastest print mode for a desired quality standard, or the highest quality achievable for a desired speed. Once the optimum print mode is defined, the media is printed using this particular print mode. It should be mentioned that a combination of print modes should also be available, for example where a print mode according to the invention would be used, whereby one (or more) particular faulty nozzle would not be compensated by another pass but using neighboring nozzles in order to increase printing speed.

Examples of print mode choices for a 1000 nozzle 2 column print zone having nozzles numbered in a manner similar to the manner illustrated in FIG. 2 being in this case nozzle 1000 being the closest to one end, nozzle 1001 being in the other column and being the second closest to the same end etc. are hereby proposed:

In one example, nozzles 205, 422, 689 and 962 are faulty. The print mode chosen was: print using nozzles 1 to 961, whereby a first advance would be of 961 nozzles, and a following advance would be of 205 nozzles. With such a mode, the average printed distance per swath would be 583 nozzles. In another example, nozzles 0, 358, 828 and 919 are faulty, and the print mode chosen was to use only nozzles 1 to 827 for printing, advance once of 359 nozzles, and then of 828 nozzles, thus obtaining an average speed of 591 nozzles per swath.

From the foregoing it will be appreciated that the method provided by the invention represents a significant advance in the art. Although specific embodiments of the invention have been described and illustrated, the invention is not to be so limited. Thus, the above described embodiments should be regarded as illustrative rather than descriptive, and it should be appreciated that variations may be made in those embodiments by workers skilled in the art without departing from the scope of the invention as described in the following claims.

What is claimed is:

1. Method of printing on a media comprising:
providing a printhead comprising a plurality of nozzles defining a print zone, at least one of the nozzles of the print zone being faulty, the print head comprising within the print zone one or more healthy zones;
submitting a first region of the media to N print zone passes; and,
submitting a second region of the media to M print zone passes using a healthy zone to overlap a faulty nozzle, at least two of the M passes being separated by an advance of the media relative to the printhead;
producing alternate first and second regions when printing on the media; whereby M>N and N>0.

2. The method according to claim 1, whereby the print zone has two or more healthy zones including a first healthy zone and a second healthy zone, and whereby the second healthy zone is shorter or equal to the first healthy zone, and whereby printing comprises the following steps:
advancing the media relative to the printhead of a first distance;
print a swath on the media;
advancing the media relative to the printhead of a second distance;
whereby the first distance is different from the second distance, the first distance being the length of the second healthy zone, and the second distance being the sum the following:
the length of the first healthy zone; and
the length of the second healthy zone; and
the space between the first and the second healthy zones
and whereby the length of the longest healthy zone is smaller or equal to the average value of the second distance and of the length of the second healthy zone.

3. The method according to claim 2, whereby the first healthy zone is on the side of a first end of the print zone and whereby the second healthy zone is on the side of the second end of the print zone opposite to the first end, and whereby any or both of the first or second healthy zone is separated from the first or respectively second end by one or more healthy zones.

4. The method according to claim 2, whereby the first healthy zone is on the side of a first end of the print zone and whereby the second healthy zone is on the side of the second end of the print zone opposite to the first end, and whereby there is no healthy zone separating one or both of the first or second healthy zone from the first or respectively second end.

5. The method according to claim 1, whereby the print zone has only one healthy zone, and whereby printing comprises the following steps:
advancing the media relative to the printhead of a first distance;
print a swath on the media;
advancing the media relative to the printhead of a second distance;
whereby the first distance is equal to the second distance, the first and the second distance being both equal to the length of the only one healthy zone.

6. The method according to claim 1, whereby a main healthy zone is identified, the main healthy zone being the longest healthy zone and the main healthy zone being longer than half the length of the print zone, whereby printing comprises the following steps:
advancing the media relative to the printhead of a first distance;
print a swath on the media;
advancing the media relative to the printhead of a second distance;
whereby the first distance is equal to the second distance, the first distance being the length of the main healthy zone.

7. The method according to claim 1, whereby printing is made by a succession of swaths, whereby each swath comprises at least part of the first region and at least part of the second region.

8. The method according to claim 1, whereby printing is made by a succession of swath, whereby each swath has a width corresponding to the length of a healthy zone.

9. The method according to claim 1, whereby each swath has a width smaller than the length of the print zone and larger that half the length of the print zone.

10. The method according to claim 1, whereby printing is made by a succession of swaths, whereby each swath differs in width from the following swath and whereby every second swaths have the same width.

11. A method of printing a media using a print head having a plurality of nozzles comprising the repetition of the following cycle:
advancing the media relative to the printhead of a first distance;
print a swath on the media;
advancing the media relative to the printhead of a second distance;
print another swath on the media;
whereby the length of the first distance and the length of the second distance are determined in function of the position of at least one faulty nozzle on the print head.

12. A method of printing according to claim 11, whereby the first distance is different from the second distance.

13. A method of printing according to claim 11, whereby the first distance is equal to the second distance.

14. A method of choosing a print mode for a print head comprising the following steps:
identify all healthy zones of a printhead, each healthy zone being included in a print zone of the print head;
choose a print mode out of a plurality of available print modes depending on the configuration of the healthy zones, whereby the plurality of available print modes includes at least one available print mode involving a method according to claim 11.

15. A method according to claim 14, whereby an available print mode involves printing any region of a media in at least two passes.

16. A method according to claim 14, whereby an available print mode involves printing by swaths, whereby each swath has the same width as the next swath.

17. A method according to claim 14, whereby each available print mode is modeled, and whereby the chosen print mode is the print mode leading to the fastest print.

18. A method according to claim 14, whereby each available print mode is modeled, and whereby the chosen print mode is the print mode leading to the highest quality print.

19. A software, optionally encoded upon a machine-readable storage medium, which when executed upon a processor causes the processor to apply the method of claim 14.

20. A printer provided with a memory and a processor, whereby the memory comprises the software according to claim 19.
